(19) United States
(12) Patent Application Publication
(10) Pub. No.: US 2023/0244859 A1
(43) Pub. Date: Aug. 3, 2023

(54) SYSTEM AND METHOD FOR AUTOMATICALLY SHARING VERIFIED USER INFORMATION ACROSS REMOTE SYSTEMS

(71) Applicant: Bank of America Corporation, Charlotte, NC (US)

(72) Inventors: Graham Marshall Wyllie, Charlotte, NC (US); Adithya Gadwale, Falls Church, VA (US); Katherine Kei-Zen Dintenfass, Lincoln, RI (US); Stephen Thomas Shannon, Charlotte, NC (US)

(21) Appl. No.: 17/591,391

(22) Filed: Feb. 2, 2022

(51) Int. Cl. G06F 40/174; G06F 40/106; G06F 40/197; G06F 40/194; G06F 16/16

(52) U.S. Cl. CPC G06F 40/174; G06F 40/106; G06F 40/197; G06F 40/194; G06F 16/168

(57) ABSTRACT

An apparatus includes a memory and a processor. The memory stores an identification of information and a document associated with an external system. The processor receives information associated with a user, and uses the information to generate a file of a first type. The processor also receives a selection of an option to initiate automatic generation of a file of a second type by the external system. In response, the processor identifies, from the information and based on the identification of the information used by the external system, a subset of information associated with the user. The processor transmits the subset to the external system. The processor additionally presents the document to the user, determines that the user edited the document, and transmits the edited document to the external system. In response to receiving the subset and the edited document, the external system generates the file of the second type.

### TECHNICAL FIELD

The present disclosure relates generally to multicomputer data transferring, and more particularly, to a system and method for automatically sharing verified user information across remote systems.

### BACKGROUND

Users of electronic systems are often asked to provide information to those systems. For example, during the process of setting up a user profile with an electronic system, a user may be asked to provide his/her name, address, phone number, etc. Frequently, this information is used by the system to which it is provided to verify the identity of the user. Because a user may be asked to provide the same information to multiple different systems, various inefficiencies may exist. This may be particularly true where each system independently expends processing and memory resources to verify the user's identity using the provided information.

### SUMMARY

This disclosure contemplates a file generating tool that is configured to receive information associated with a user and to generate a file for that user, using the provided information. As part of this process, the tool may be configured to verify the identity of the user. After generating a file for the user, the tool is configured to present the user with the option of having the tool share the user's information with one or more external systems, which will use the information to generate their own files associated with the user. In particular, in response to the user selecting the option to share his/her information with a given external system, the tool is configured to communicate with that external system and to initiate generation and/or modification of an external file associated with the user and stored with that external system.

Because the file generating tool is configured to automatically cooperate with one or more external systems to have those external systems generate and/or modify external files associated with the user, certain embodiments of the tool eliminate and/or reduce the need for the user to separately communicate with each external system. In this manner, certain embodiments of the tool reduce the processing and networking resources consumed by a device associated with the user. Similarly, because the tool may have already used the information provided by the user to verify the user's identity, in certain embodiments, external systems to which the tool communicates this verified information and which would typically perform their own verification of the user's identity, may skip such identity verification. Thus, certain embodiments conserve the processing and networking resources that would otherwise be consumed by multiple external systems each performing its own identity verification process. An embodiment of the tool is described below.

According to an embodiment, an apparatus includes a memory and a hardware processor communicatively coupled to the memory. The memory stores an identification of information associated with a first external system, and a first document associated with the first external system. The first document incudes at least one field editable by a user. The hardware processor receives, through a graphical user interface displayed on a device of the user, a set of information associated with the user. In response to receiving the set of information, the hardware processor generates, using the set of information, a file of a first type. The hardware processor also presents, on the graphical user interface, a first option to initiate automatic generation of a file of a second type by the first external system. The hardware processor additionally receives a selection of the first option. In response to receiving the selection of the first option, the hardware processor identifies, from the set of information associated with the user and based on the identification of the information used by the first external system, a first subset of information associated with the user. The hardware processor also transmits the first subset of information to the first external system. The hardware processor additionally presents, through the graphical user interface, the first document. The hardware processor also determines that the user edited the at least one editable field of the first document. The hardware processor further transmits the edited first document to the first external system. In response to receiving the first subset of information and the edited first document, the first external system generates the file of the second type, and stores the file of the second type in a memory of the first external system.

The tool described in the present disclosure provides a practical application by reducing the processing and networking resources that would otherwise be expended by a user during the process of setting up multiple files with different systems. In particular, because the tool is configured to communicate the user's information to a set of external systems selected by the user, certain embodiments avoid the need for the user to provide his/her information separately to each of those external systems. This in turn reduces the processing and networking resources that would otherwise be consumed by the user's computational device in setting up the various files stored with the external systems. Additionally, because certain embodiments of the tool are configured to use the information provided by the user to verify the user's identity, the external systems that subsequently receive the information may be confident that the user's identity is verified, without performing such verification themselves. Thus, certain embodiments further conserve the processing and networking resources that would be expended by the repeated verification of the user's identity by those external systems that are configured to perform such identity verification.

Certain embodiments may include none, some, or all of the above technical advantages. One or more other technical advantages may be readily apparent to one skilled in the art form the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates an example file generating and information sharing system; and

FIG. 2 illustrates an example process by which the file generating tool of the system of FIG. 1 gathers user information and provides that information to external systems specified by the user, for use by those external systems in generating and/or modifying files associated with the user.

### DETAILED DESCRIPTION

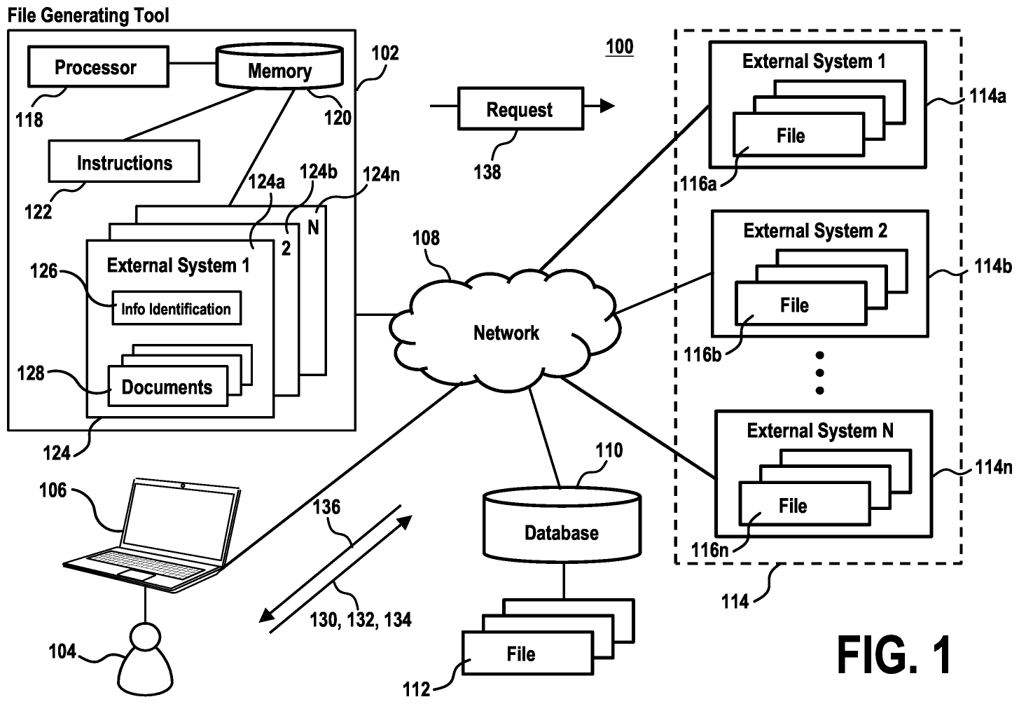

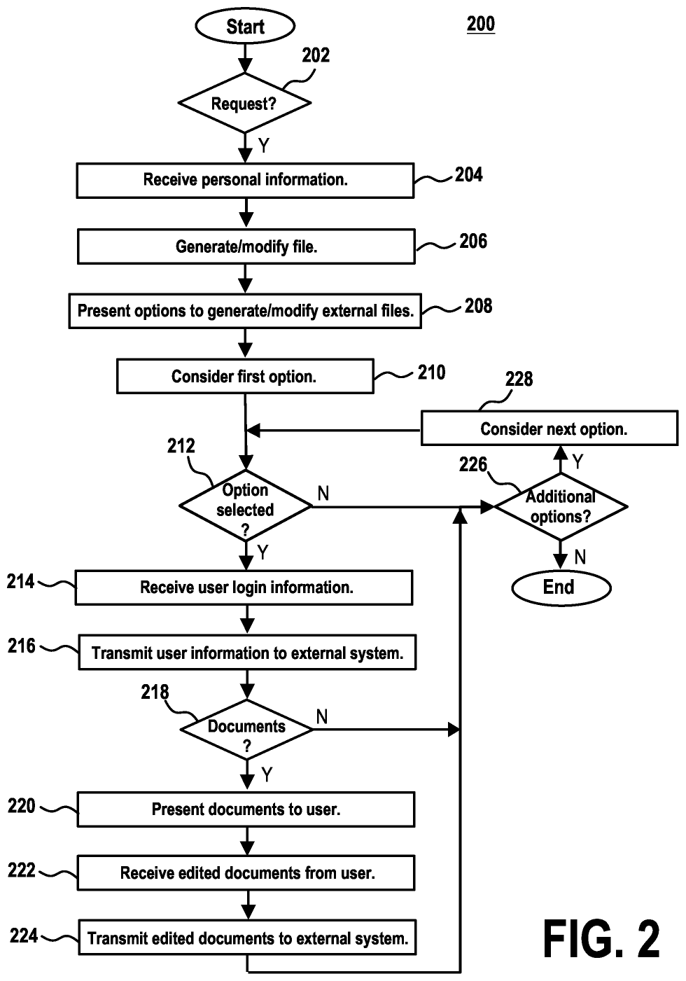

Embodiments of the present disclosure and its advantages may be understood by referring to FIGS. 1 and 2 of the drawings, like numerals being used for like and corresponding parts of the various drawings.

### I. System Overview

FIG. 1 illustrates an example file generating and information sharing system 100 that includes user(s) 104, device(s) 106, network 108, database 110, external systems 114a through 114n, and file generating tool 102. File generating tool 102 belongs to an entity to which user 104 may provide information 132 that is used to generate a file 112 associated with the user. As used throughout this disclosure, the term “file” may refer to any user-specific collection of information stored by an electronic system. For example, a “file” may correspond to a user profile, an online account (e.g., an online shopping account, an online dating account, a banking account, a social media account, etc.), and/or any other suitable collection of user-specific information stored by an electronic computer system. In certain embodiments, each file may be associated with a set of login credentials, which user 104 may use to access the information stored in the file. As illustrated in FIG. 1, external systems 114a through 114n are also configured to generate and store files associated with user 104 (files 116a through 116n, respectively). Each of files 112, and 116a through 116n is typically different from the others. For example, file 112 may be of a first type (e.g., file 112 may correspond to an online banking account), file 116a may be of a second type (e.g., file 116a may correspond to a social media account), etc. However, because they are associated with the same user 104, such files may include much of the same information. For example, each of files 112, and 116a through 116n may store the name, phone number, and/or any other suitable identification of user 104. If user 104 were required to provide this same information separately to each of file generating tool 102 and external systems 114a through 114n, the process would likely be time-consuming and computationally inefficient.

File generating tool 102 is configured to avoid such inefficiencies. In particular, in response to user 104 providing the tool with information 132 for use by the tool in generating a file 112, the tool is configured to provide the user with the option of having the tool automatically communicate with one or more of external systems 114a through 114n and facilitate the generation of the corresponding files 116 by such external systems for user 104. Further details of the manner by which file generating tool 102 performs such tasks are presented below, and in the discussion of FIG. 2.

Device(s) 106 are used by user(s) 104 to communicate with components of system 100. As an example, a user 104 may use device 106 to transmit a request 130 to file generating tool 102, requesting that the tool generate a file 112 for user 104. In certain embodiments, request 130 may include information 132 to be used by file generating tool 102 in generating file 112. In some embodiments, user 104 may transmit such information separately to tool 102. For example, in some embodiments, file generating tool 102 may be configured to generate a graphical user interface (GUI), which may be displayed on device 106. User 104 may interact with the GUI (e.g., click on/touch a button displayed on the GUI) to transmit request 130 to file generating tool 102. In response to user 104 transmitting request 130 to file generating tool 102, the tool 102 may cause the GUI to display a set of interactive fields through which user 104 may interact (e.g., type, click on, etc.) to provide information 132 to file generating tool 102. Information 132 may be any suitable information associated with user 104. For example, information 132 may correspond to personally identifiable information of user 104 (e.g., name, address, telephone number, social security number, credit card number, etc.).

Devices 106 may also be used by users 104 to receive communications from file generating tool 102. For example, in response to the tool generating file 112 for user 104, the tool may transmit a set of options 136 to user 104. For each external system 114a through 114n, set of options 136 provides user 104 with the option of having file generating tool 102 use the information 132 received from user 104 to automatically initiate the generation of the corresponding file 116a through 116n by the external system.

As another example of the manner by which user 104 may use device 106 to communicate with components of system 100, in certain embodiments, user 104 may use device 106 to request access to one or more of files 112 and/or 116a through 116n. User 104 may further use device 106 to view one or more of files 112 and/or 116a through 116n, and/or to edit the content of one or more of files 112 and/or 116a through 116n. In certain embodiments, in response to user 104 editing the content of file 112, file generating tool 102 is configured to communicate with one or more of external systems 114a through 114n and instruct those systems to correspondingly edit the content of files 116a through 116n, where relevant. For example, if user 104 changes his/her last name in file 112, file generating tool 102 may communicate with any of externals systems 114a through 114n that store files 116a through 116n that include the user's name and instruct those external systems to change the user's last name to reflect the change made to file 112.

Devices 106 include any appropriate device for communicating with components of system 100 over network 108. For example, devices 106 may include a mobile phone, a computer, a laptop, a wireless or cellular telephone, a tablet, a server, an IoT device, and/or an automated assistant, among others. This disclosure contemplates devices 106 being any appropriate device for sending and receiving information over network 108, and/or displaying information. In some embodiments, device 106 may include a display, a keypad, or other appropriate terminal equipment usable by user 104. In some embodiments, an application executed by a processor of device 106 may perform the functions described herein.

Network 108 facilitates communications between components of system 100 including, for example, file generating tool 102, device(s) 106, database 110, and/or external systems 114a through 114n. Network 108 may include any interconnecting systems capable of transmitting audio, video, signals, data, messages, or any combination of the preceding. For example, network 108 may include all or a portion of a public switched telephone network (PSTN), a public data network, a metropolitan area network (MAN), a wide area network (WAN), a local, regional, or global communication or computer network, such as the Internet, a wireline or wireless network, or any other suitable communication link, including combinations thereof, operable to facilitate communication between components of system 100. While illustrated in FIG. 1 as a single network 108, in certain embodiments, network 108 may include multiple networks. For example, network 108 may include an internal network belonging to the entity to which file generating tool 102 belongs and an external network, such as the Internet. In some such embodiments, database 110 may be accessible over the internal portion of network 108, while external systems 114a through 114n may be accessible over the external portion of network 108.

Database 110 is any storage location where file 112 is stored. As described above, file 112 is any user-specific collection of information generated by file generating tool 102 and stored in database 110. For example, file 112 may correspond to a user profile, a banking account, and/or any other collection of user-specific information generated by file generating tool 102 based on information 132 provided by user 104. While illustrated in FIG. 1 as storing a single file 112, database 110 may store any number of files 112. For example, database 110 may store a first file 112 associated with a first user 104, a second file 112 associated with a second user 104, etc. Additionally, while illustrated in FIG. 1 as being a single database, database 110 may correspond to any number of storage locations. For example, database 110 may correspond to one or more databases, servers, local storage systems, cloud storage systems, and/or any other suitable storage location.

As illustrated in FIG. 1, file generating tool 102 includes processor 118 and memory 120. This disclosure contemplates processor 118 and memory 120 being configured to perform any of the functions of file generating tool 102 described herein. Generally, file generating tool 102 is configured to: (1) receive a request 130 from user 104 to generate and/or modify a file 112; (2) receive information 132 from user 104 and use the received information to generate/modify file 112; (3) present user 104 with options 136 to generate/modify external files 116a through 116n associated with external systems 114a through 114n, respectively; (4) receive a selection 134 from user 104 of one or more external systems 114 for which file generating tool 102 is to communicate on behalf of user 104 in order to cause the external system(s) to generate/modify external file(s) 116; (5) for each selected external system 114, transmit a request 138 to the external system to generate/modify a file 116 associated with user 104, where the request includes information associated with user 104 and used by the external system to generate/modify the external file 116. The manner by which file generating tool 102 performs these functions is described in further detail below, and in the discussion of FIG. 2.

Processor 118 is any electronic circuitry, including, but not limited to central processing units (CPUs), graphics processing units (GPUs), microprocessors, application specific integrated circuits (ASIC), application specific instruction set processor (ASIP), and/or state machines, that communicatively couples to memory 120 and controls the operation of file generating tool 102. Processor 118 may be 8-bit, 16-bit, 32-bit, 64-bit or of any other suitable architecture. Processor 118 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processor 118 may include other hardware and software that operates to control and process information. Processor 118 executes software (e.g., instructions 122) stored on memory 120 to perform any of the functions described herein. Processor 118 controls the operation and administration of file generating tool 102 by processing information received from device(s) 106, network 108, database 110, external systems 114a through 114n, and/or memory 120. Processor 118 may be a programmable logic device, a microcontroller, a microprocessor, any suitable processing device, or any suitable combination of the preceding. Processor 118 is not limited to a single processing device and may encompass multiple processing devices.

Memory 120 may store, either permanently or temporarily, data, operational software, or other information/instructions 122 for processor 118. Memory 120 may include any one or a combination of volatile or non-volatile local or remote devices suitable for storing information. For example, memory 120 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 120, a disk, a CD, or a flash drive. In particular embodiments, the software may include an application executable by processor 118 to perform one or more of the functions described herein.

Memory 120 is also configured to store a data set 124 associated with each external system 114. For example, memory 120 is configured to store data set 124a that is associated with first external system 114a, data set 124b that is associated with second external system 114b, and data set 124n that is associated with Nth external system 114n. The data set 124 associated with a given external system 114 includes an identification 126 of the information used by the external system to generate a file 116, along with one or more documents 128. In certain embodiments, the identification 126 of the information used by the external system 114 identifies a subset of the information 132 provided by user 104 to file generating tool 102. For example, identification 126 may indicate that external system 124a uses a name and a phone number to generate file 116a, which are also received by file generating tool 102 in information 132 and used to generate file 112. In some embodiments, the identification 126 of the information used by the external system 114 identifies information generated by tool 102 and stored in file 112. For example, identification 126 may indicate that external system 124b uses an account number generated for user 104 and stored in file 112. As a specific example, in certain embodiments, file generating tool 102 may belong to an online banking system and external system 114b may correspond to an online marketplace, with file 112 corresponding to a bank account and file 116b corresponding to a merchant account. In certain such embodiments, the identification 126 of the information used by external system 114b to generate merchant account 116b may include an identification of bank account information stored in bank account 112. In this manner, merchant account 116b may be linked to bank account 112 such that payments received by merchant account 116b may be automatically deposited into user 104′s bank account 112.

The one or more documents 128 stored within data set 124 for a given external system 114 correspond to documents that would typically be presented to user 104 by the external system 114 as part of the process of generating file 116. As an example, if user 104 were to communicate directly with external system 114a to generate file 116a, external system 114a would transmit documents 128 to user 104 as part of the process of generating file 116a. Documents 128 may correspond to any documents that an electronic system may transmit to its users prior to generating and storing files 116 associated with those users. As an example, in certain embodiments, documents 128 include a terms of service document that explains the terms of service of the external system 114. As another example, in certain embodiments, documents 128 includes a privacy policy of the external system 114. As a further example, in certain embodiments, documents 128 may include a document requesting the user's consent and/or acknowledgment. In some embodiments, documents 128 include one or more fields that are editable by user 104. For example, one or more of documents 128 may include a field for user 104 to insert his/her signature.

External systems 114 correspond to any electronic systems with which user 104 may generate and store a file 116 associated with the user. For example, first external system 114a corresponds to an electronic system configured to generate and store a file 116a, second external system 114b corresponds to an electronic system configured to generate and store a file 116b, and Nth external system 114n corresponds to an electronic system configured to generate and store a file 116n. Files 116a through 116n may be of the same or different types. For example, one or more of files 116a through 116n may correspond to an online dating profile of user 104, a social media account belonging to user 104, a banking account belonging to user 104, an online shopping account of user 104, a merchant account belonging to user 104, and/or any other suitable type of profile, account, or other collection of information associated with user 104.

In certain embodiments, file generating tool 102 may be configured to communicate with one or more of external systems 114a through 114n to generate the corresponding file 116a through 116n (e.g., the file may not exist prior to file generating tool 102 communicating with the external system). In some embodiments, file generating tool 102 may be configured to communicate with one or more of external systems 114a through 114n to modify an existing version of the corresponding file 116a through 116n. As an example, in certain embodiments in which file 112 is an online banking account and file 116a corresponds to a merchant account, file generating tool 102 may be configured to add information associated with file 112 (e.g., bank account number) to file 116a, thereby linking online banking account 112 and merchant account 116a.

While illustrated in FIG. 1 as each of external systems 114a through 114n storing a file 116a through 116n associated with user 104, this disclosure contemplates that any number (including none) of external systems 114a through 114n may store a file 116a through 116n associated with user 104. For example, in response to file generating tool 102 presenting user 104 with a set of options to automatically initiate generation of files 116a through 116n, user 104 may decline all or a subset of those options.

Additionally, while illustrated in FIG. 1 as each of database 110, and external systems 114a through 114n storing a single file 112 and 116a through 116n, respectively, this disclosure contemplates that each of database 110 and external systems 114a through 114n may store any suitable number of files, with each file corresponding to a given user 104.

Modifications, additions, or omissions may be made to the systems described herein without departing from the scope of the invention. For example, system 100 may include any number of existing users 104, devices 106, networks 108, databases 110, files 112, external systems 114, files 116a through 116n, processors 118, memories 120, data sets 124, identifications 126, and documents 128. The components may be integrated or separated. Moreover, the operations may be performed by more, fewer, or other components. Additionally, the operations may be performed using any suitable logic comprising software, hardware, and/or other logic.

### II. Process for Automatically Identifying Threat Models for which a Newly Identified Threat is Relevant

FIG. 2 presents a flowchart illustrating an example method 200 (described in conjunction with elements of FIG. 1) used by file generating tool 102 to gather user information 132 and to provide a subset of that information to one or more external systems 114 specified by user 104, for use by those external systems in generating and/or modifying external files 116 associated with user 104.

During process 202 file generating tool 102 determines whether it has received a request 130 from a user 104 to generate and/or modify a file 112. As described above, file 112 corresponds to any suitable collection of user information generated and stored by the entity to which file generating tool 102 belongs. For example, file 112 may correspond to a user profile (e.g., dating profile, social media profile, etc.), a user account (e.g., a banking account, an online merchant account, etc.), and/or any other suitable collection of user-specific information. In certain embodiments, determining that a request 130 has been received from user 104 includes determining that user 104 has interacted with a GUI (e.g., clicked on/touched a button displayed on the GUI) generated by file generating tool 102 and displayed on device 106 of user 104.

If, during process 202 file generating tool 102 determines that it has received a request 130 from user 104 to generate and/or modify file 112, during process 204 the tool receives information 132 from user 104 for use in generating and/or modifying file 112. Information 132 may be any suitable information associated with user 104. As an example, in certain embodiments, information 132 may correspond to personally identifiable information of user 104. For instance, information 132 may include a name, date of birth, address, telephone number, social security number, and/or any other suitable personal information associated with user 104. During process 206 file generating tool 102 uses the receive information 132 to generate and/or modify file 112. As an example, in certain embodiments in which file 112 corresponds to an online banking account, file generating tool 102 may use the information 132 to generate an online banking account belonging to the user. This may include generating a bank account number for the user. In some embodiments, generating file 112 may include using the personal information 132 provided by user 104 to verify the identity of the user. For example, file generating tool 102 may provide this information to one or more external identity verification systems to verify the identity of the user. File generating tool 102 may receive information 132 in any suitable manner. For example, in certain embodiments in which file generating tool 102 is configured to generate a GUI for display on device 106 of user 104, the GUI is configured to display a set of fields through which user 104 may enter information 132.

During process 208 file generating tool 102 next presents user 104 with the option of having the tool automatically initiate the generation/modification of one or more external files 116, stored by external systems 114, on behalf of the user. File generating tool 102 may present user 104 with these options in any suitable manner. For example, in certain embodiments, file generating tool 102 may display the options as elements on a GUI, which are selectable by user 104. During process 210 file generating tool 102 considers the first option presented to user 104. During process 212 file generating tool 102 determines whether user 104 selected the option currently being considered. If, during process 212 file generating tool 102 determines that user 104 did not select the option currently being considered, during process 226 file generating tool 102 determines whether any additional options were presented to user 104. If, during process 226 file generating tool 102 determines that one or more additional options were presented to user 104, during process 228 file generating tool 102 considers the next option that was presented to user 104. Method 200 then returns to process 212.

If, during process 212 file generating tool 102 determines that user 104 selected the option currently being considered, in certain embodiments, during process 214 file generating tool 102 receives the login credentials of user 104 for the external system 114 associated with the selected option. For example, in embodiments in which the option selected by user 104 is the option to modify an existing file 116a associated with user 104 and stored in external system 114a, the login credentials received during process 214 correspond to the login credentials that user 104 would use to log into external system 114a to access file 116a. As another example, in embodiments in which the option selected by user 104 is the option to generate a new file 116b associated with user 104 and stored in external system 114b, the login credentials received during process 214 may correspond to the login credentials that user 104 would like to be associated with file 114b when the file is generated (e.g., the login credentials do not already exist and correspond to the login credentials that the user would like to be created).

During process 216 file generating tool 102 transmits a request 138 to the external system 114 associated with the selected option, requesting that the external system generate and/or modify a file 114 stored by the external system and associated with user 104, using information provided by the tool. The information provided by file generating tool 102 in request 138 is information associated with user 104 and identified by the tool using the information identification 126 stored in memory 120 for the corresponding external system 114. For example, where user 104 has selected the option to have file generating tool 102 cooperate with first external system 114a to generate external file 116a for user 104, file generating tool 102 uses information identification 126 stored within the data set 124 corresponding to first external system 114a and stored in memory 120. Information identification 126 may identify any suitable information associated with user 104 and received and/or generated by file generating tool 102. For example, information identification 126 may identify a subset of the information 132 provided by user 104 to file generating tool 102 to generate file 112. As another example, information identification 126 may identify information stored in file 112 and generated based on the information 132 provided by user 104 to file generating tool 102 (e.g., an account number). File generating tool 102 may provide the information identified in information identification 126 to external system 114 in any suitable manner. For example, in certain embodiments, file generating tool 102 transmits a package of information (which may include the login credentials of the user) to external system 114 as part of request 138. As another example, in some embodiments, file generating tool 102 may use the login credentials of the user to log into external system 114 and act on behalf of user 104 to provide the information identified through information identification 126 to external system 114 as requested.

During process 218 file generating tool 102 determines whether any documents 128 belonging to the external system 114 associated with the selected option are stored in memory 120. As described above, documents 128 correspond to documents that would typically be presented to user 104 by external system 114 during the process of generating and/or modifying a file 116. For example, one or more of documents 128 may correspond to a terms of service document, a consent document, an acknowledgement document, a privacy policy, and/or any other suitable document that may be provided to user 104 as part of the process of generating/modifying file 116. If, during process 218 file generating tool 102 determines that no documents 128 belonging to the external system 114 are stored in memory 120, method 200 continues to process 226.

If, during process 218 file generating tool 102 determines that one or more documents 128 belonging to external system 114 are stored in memory 120, during process 220 file generating tool 102 presents the one or more documents 128 to user 104. File generating tool 102 may present documents 128 to user 104 in any suitable manner. For example, in certain embodiments, file generating tool 102 may display documents 128 on a GUI displayed on device 106. As another example, in some embodiments, file generating tool 102 may transmit documents 128 to user 104 via email, SMS, and/or in any other suitable manner.

In certain embodiments, one or more of documents 128 may include a field editable by user 104. As an example, in certain embodiments, one or more of documents 128 may include a box for user 104 to check, a set of options for user 104 to select from amongst, and/or a field into which user 104 may enter his/her signature. In such embodiments, during process 222 file generating tool 102 receives the edited versions of documents 128 back from user 104. As an example, in certain embodiments, during process 222 file generating tool 102 determines that user 104 has entered his/her electronic signature into one or more of documents 128. During process 224 file generating tool 102 transmits the edited versions of documents 128 to external system 114. Method 200 then continues to process 226.

In response to receiving the information provided by file generating tool 102 in request 138 and the edited versions of documents 128, the external system 114 is configured to generate a file 116 that is associated with user 104. In certain embodiments, because external system 114 received user 104′s information from file generating system 102 rather than user 104 him/herself, external system 114 may forgo verifying user 104′s identity on the basis that file generating system 102 has already verified the user's identity. Accordingly, certain embodiments of file generating tool 102 conserve the processing and networking resources that would otherwise be expended by external systems 114 each independently verifying user 104′s identity.

Modifications, additions, or omissions may be made to method 200 depicted in FIG. 2. Method 200 may include more, fewer, or other steps. For example, steps may be performed in parallel or in any suitable order. While discussed as file generating tool 102 (or components thereof) performing certain steps, any suitable components of system 100, including, for example, devices 106 and external systems 114, may perform one or more steps of the method.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as falling within the scope of the appended claims.

What is claimed is:

1. An apparatus comprising:
a memory configured to store:
an identification of information associated with a first external system; and
a first document associated with the first external system, the first document comprising at least one field editable by a user; and
a hardware processor communicatively coupled to the memory, the hardware processor configured to:
receive, through a graphical user interface displayed on a device of the user, a set of information associated with the user;
in response to receiving the set of information:
generate, using the set of information, a file of a first type;
present, on the graphical user interface, a first option to initiate automatic generation of a file of a second type by the first external system;
receive a selection of the first option; and
in response to receiving the selection of the first option:
identify, from the set of information associated with the user and based on the identification of the information used by the first external system, a first subset of information associated with the user;
transmit the first subset of information to the first external system;
present, through the graphical user interface, the first document;
determine that the user edited the at least one editable field of the first document; and
transmit the edited first document to the first external system, wherein in response to receiving the first subset of information and the edited first document, the first external system is configured to:
generate the file of the second type; and
store the file of the second type in a memory of the first external system.

2. The apparatus of claim 1, wherein:
the memory is further configured to store:
an identification of information associated with a second external system; and
a second document associated with the second external system, the second document comprising at least one field editable by the user; and
in response to receiving the set of information, the hardware processor is further configured to:
present, on the graphical user interface, a second option to initiate automatic generation of a file of a third type by the second external system;
receive a selection of the second option; and
in response to receiving the selection of the second option:
identify, from the set of information associated with the user and based on the identification of the information used by the second external system, a second subset of information associated with the user;
transmit the second subset of information to the second external system;
present, through the graphical user interface, the second document;
determine that the user edited the at least one editable field of the second document; and
transmit the edited second document to the second external system, wherein in response to receiving the second subset of information and the edited second document, the second external system is configured to:
generate the file of the third type; and
store the file of the third type in a memory of the second external system.

3. The apparatus of claim 1, wherein:
in response to receiving the selection of the first option, the hardware processor is further configured to:
present, on the graphical user interface, a request for login credentials of the user, the login credentials associated with the first external system; and
receive the login credentials; and
transmitting the first subset of information to the first external system comprises using the login credentials to access the first external system.

4. The apparatus of claim 1, wherein determining that the user edited the at least one editable field of the first document comprises determining that the user signed the first document.

5. The apparatus of claim 1, wherein:
the memory is further configured to store:
an identification of information associated with a second external system; and
a second document associated with the second external system, the second document comprising at least one field editable by the user; and
in response to receiving the set of information, the hardware processor is further configured to:
present, on the graphical user interface, a second option to initiate automatic generation of a file of a third type by the second external system; and
determine that the user did not select the second option.

6. The apparatus of claim 1, wherein:
the set of information comprises a first piece of information;
the identification of information associated with the first external system identifies the first piece of information; and
the hardware processor is further configured to:
receive an updated version of the first piece of information from the user;
in response to receiving the updated version of the first piece of information from the user:
update the first file based on the updated version of the first piece of information;
determine that the identification of information associated with the first external system identifies the first piece of information; and
in response to determining that the identification of information associated with the first external system identifies the first piece of information, transmit the updated version of the first piece of information to the first external system, wherein in response to receiving the updated version of the first piece of information, the first external system is further configured to update the second file based on the updated version of the first piece of information.

7. The apparatus of claim 1, wherein:
the set of information comprises personal identification information of the user;
the first file comprises a profile of the user; and
the hardware processor is further configured to verify, based on the set of information, an identity of the user.

8. A method comprising:
receiving, through a graphical user interface displayed on a device of a user, a set of information associated with the user;
in response to receiving the set of information:
generating, using the set of information, a file of a first type;
presenting, on the graphical user interface, a first option to initiate automatic generation of a file of a second type by a first external system;
receiving a selection of the first option; and
in response to receiving the selection of the first option:
identifying, from the set of information associated with the user and based on an identification of information associated with the first external system, a first subset of information associated with the user;
transmitting the first subset of information to the first external system;
presenting, through the graphical user interface, a first document associated with the first external system, the first document comprising at least one field editable by the user;
determining that the user edited the at least one editable field of the first document; and
transmitting the edited first document to the first external system, wherein in response to receiving the first subset of information and the edited first document, the first external system is configured to:
generate the file of the second type; and
store the file of the second type in a memory of the first external system.

9. The method of claim 8, wherein in response to receiving the set of information, the method further comprises:
presenting, on the graphical user interface, a second option to initiate automatic generation of a file of a third type by a second external system;
receiving a selection of the second option; and
in response to receiving the selection of the second option:
identifying, from the set of information associated with the user and based on an identification of information associated with the second external system, a second subset of information associated with the user;
transmitting the second subset of information to the second external system;
presenting, through the graphical user interface, a second document associated with the second external system, the second document comprising at least one field editable by the user;
determining that the user edited the at least one editable field of the second document; and
transmitting the edited second document to the second external system, wherein in response to receiving the second subset of information and the edited second document, the second external system is configured to:
generate the file of the third type; and
store the file of the third type in a memory of the second external system.

10. The method of claim 8, wherein:
in response to receiving the selection of the first option, the method further includes:
presenting, on the graphical user interface, a request for login credentials of the user, the login credentials associated with the first external system; and
receiving the login credentials; and
transmitting the first subset of information to the first external system comprises using the login credentials to access the first external system.

11. The method of claim 8, wherein determining that the user edited the at least one editable field of the first document comprises determining that the user signed the first document.

12. The method of claim 8, wherein, in response to receiving the set of information, the method further comprises:
presenting, on the graphical user interface, a second option to initiate automatic generation of a file of a third type by a second external system; and
determining that the user did not select the second option.

13. The method of claim 8, further comprising:
receiving an updated version of a first piece of information from the user, wherein the set of information comprises the first piece of information;
in response to receiving the updated version of the first piece of information from the user:
updating the first file based on the updated version of the first piece of information;
determining that the identification of information associated with the first external system identifies the first piece of information; and
in response to determining that the identification of information associated with the first external system identifies the first piece of information, transmitting the updated version of the first piece of information to the first external system, wherein in response to receiving the updated version of the first piece of information, the first external system is further configured to update the second file based on the updated version of the first piece of information.

14. The method of claim 8, wherein:
the set of information comprises personal identification information of the user;
the first file comprises a profile of the user; and
the method further comprises verifying, based on the set of information, an identity of the user.

15. A system comprising:
a first external system comprising a first memory and a first hardware processor communicatively coupled to the first memory;
a second memory configured to store:
an identification of information associated with the first external system; and
a first document associated with the first external system, the first document comprising at least one field editable by a user; and
a second hardware processor communicatively coupled to the second memory, the second hardware processor configured to:
generate a graphical user interface for display on a device of the user;
receive, through the graphical user interface, a set of information associated with the user;
in response to receiving the set of information:
generate, using the set of information, a file of a first type;
present, on the graphical user interface, a first option to initiate automatic generation of a file of a second type by the first external system;
receive a selection of the first option; and
in response to receiving the selection of the first option:
identify, from the set of information associated with the user and based on the identification of the information used by the first external system, a first subset of information associated with the user;
transmit the first subset of information to the first external system;
present, through the graphical user interface, the first document;
determine that the user edited the at least one editable field of the first document; and
transmit the edited first document to the first external system, wherein in response to receiving the first subset of information and the edited first document, the first hardware processor is configured to:
generate the file of the second type; and
store the file of the second type in the first memory.

16. The system of claim 15, further comprising a second external system comprising a third memory and a third hardware processor communicatively coupled to the third memory, wherein:
the second memory is further configured to store:
an identification of information associated with the second external system; and
a second document associated with the second external system, the second document comprising at least one field editable by the user; and
in response to receiving the set of information, the second hardware processor is further configured to:
present, on the graphical user interface, a second option to initiate automatic generation of a file of a third type by the second external system;
receive a selection of the second option; and
in response to receiving the selection of the second option:
identify, from the set of information associated with the user and based on the identification of the information used by the second external system, a second subset of information associated with the user;
transmit the second subset of information to the second external system;
present, through the graphical user interface, the second document;
determine that the user edited the at least one editable field of the second document; and
transmit the edited second document to the second external system, wherein in response to receiving the second subset of information and the edited second document, the third hardware processor is configured to:
generate the file of the third type; and
store the file of the third type in the third memory.

17. The system of claim 15, wherein:
in response to receiving the selection of the first option, the second hardware processor is further configured to:
present, on the graphical user interface, a request for login credentials of the user, the login credentials associated with the first external system; and
receive the login credentials; and
transmitting the first subset of information to the first external system comprises using the login credentials to access the first external system.

18. The system of claim 15, wherein determining that the user edited the at least one editable field of the first document comprises determining that the user signed the first document.

19. The system of claim 15, further comprising a second external system, wherein:
the second memory is further configured to store:
an identification of information associated with the second external system; and
a second document associated with the second external system, the second document comprising at least one field editable by the user; and
in response to receiving the set of information, the second hardware processor is further configured to:
present, on the graphical user interface, a second option to initiate automatic generation of a file of a third type by the second external system; and
determine that the user did not select the second option.

20. The system of claim 15, wherein:
the set of information comprises a first piece of information;
the identification of information associated with the first external system identifies the first piece of information; and
the second hardware processor is further configured to:
receive an updated version of the first piece of information from the user;
in response to receiving the updated version of the first piece of information from the user:
update the first file based on the updated version of the first piece of information;
determine that the identification of information associated with the first external system identifies the first piece of information; and
in response to determining that the identification of information associated with the first external system identifies the first piece of information, transmit the updated version of the first piece of information to the first external system, wherein in response to receiving the updated version of the first piece of information, the first hardware processor is further configured to update the second file based on the updated version of the first piece of information.
